(19) United States
(12) Patent Application Publication
(10) Pub. No.: US 2014/0073793 A1
(43) Pub. Date: Mar. 13, 2014

(54) Germanium-containing camptothecin analogues

(71) Applicants: Xinghai Chen, San Antonio, TX (US); Harry Kochat, San Antonio, TX (US); Pavankumar N.V. Petluru, San Antonio, TX (US); Aulma Parker, San Antonio, TX (US); Frederick H. Hausheer, Fair Oaks Ranch, TX (US)

(72) Inventors: Xinghai Chen, San Antonio, TX (US); Harry Kochat, San Antonio, TX (US); Pavankumar N.V. Petluru, San Antonio, TX (US); Aulma Parker, San Antonio, TX (US); Frederick H. Hausheer, Fair Oaks Ranch, TX (US)

(73) Assignee: BioNumeric Pharmaceuticals, Inc.

(21) Appl. No.: 13/573,294

(22) Filed: Sep. 7, 2012

(51) Int. Cl. C07F 7/30

(52) U.S. Cl. 546/10

(57) ABSTRACT

The present invention discloses: (i) the novel germanium-containing camptothecin compound, 7[2′-trimethylgermanyl]ethyl-20(S) camptothecin, and pharmaceutically-acceptable salts thereof; (ii) methods of synthesis of said novel germanium-containing camptothecin compound, 7[2′-trimethylgermanyl]ethyl-20(S) camptothecin, and pharmaceutically-acceptable salts; (iii) pharmaceutically-acceptable formulations comprising said novel germanium-containing camptothecin compound, 7[2′-trimethylgermanyl]ethyl-20(S) camptothecin, and pharmaceutically-acceptable salts thereof; and (iv) methods of administration of said novel germanium-containing camptothecin compound, 7[2′-trimethylgermanyl]ethyl-20(S) camptothecin, and pharmaceutically-acceptable salts thereof to subjects in need thereof, including subjects with cancer.

### FIELD OF THE INVENTION

This invention relates to novel analogues of camptothecin and will have application to highly lipophilic camptothecin derivatives (HLCDs) that include a germanium-containing substitution moiety at one or more of C7, C9, C10, C11, C12 or C5 of the camptothecin scaffold.

### BACKGROUND OF THE INVENTION

Camptothecin (CPT) and certain of its derivatives are potent antineoplastic agents that are currently the subject of numerous ongoing scientific investigations. Recently, the Untied States Food and Drug Administration (FDA) approved the first two CPT derivatives (Irinotecan and Topotecan, discussed below) for human use as therapy for various forms of solid neoplasms. The structure of camptothecin, with the colloquially accepted numbering scheme is shown below.

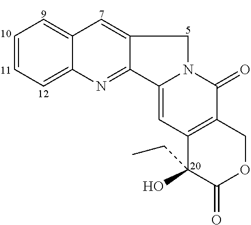 [SMILES: CC[C@@]1(O)C(=O)OCc2c1cc1n(c2=O)Cc2cc3ccccc3nc2-1]

Camptothecin was initially isolated in 1966 by Wall and Wani from Camptotheca accuminata, a Chinese yew. CPT was subsequently observed to have potent anti-cancer activity and was introduced into human clinical trials in the late-1970's. The closed E-ring lactone form of CPT was noted to be very poorly water soluble (with only approximately 0.1 microgram of drug dissolving in 1 mL of water). In order for CPT to be administered in human clinical trials it was first formulated with sodium hydroxide. This formulation resulted in hydrolysis of the lactone E-ring of the camptothecin molecule and formed the water soluble carboxylate species. The sodium hydroxide formulation of CPT created a water soluble CPT species that permitted clinicians to administer larger doses of the drug to cancer patients undergoing Phase I and Phase II clinical trials. However, it was not learned until much later that the carboxylate form of CPT had approximately one-tenth or less of the anti-tumor potency of the lactone form of CPT. Clinical trials with sodium hydroxide formulated CPT were disappointing due to the frequently observed significant systemic toxicities and the lack of antineoplastic activity, and clinical studies of CPT were halted in the early-1980's.

Further clinical development of CPT derivatives was not pursued until the mid-1980s. At that time it was reported that CPT had a unique mechanism of action involving the inhibition of DNA synthesis and DNA replication by interactions with the ubiquitous cellular enzyme Topoisomerase I (Topo I). This new information about the mechanism of action of CPT derivatives rekindled the interest in developing new Topo I inhibitors as antineoplastic drugs and subsequently several research groups began attempting to develop new CPT derivatives for cancer therapy. In general, it was observed that, like CPT, many of its derivatives were also very poorly soluble in water (less than 1 μg/mL). This low water solubility greatly limited the practical clinical utility of the drug because prohibitively large volumes, of fluid had to be administered to the patient in order to provide an effective dose of the drug. Because of the potent antineoplastic activity and poor water solubility of CPT and many of its derivatives in water, a great deal of research effort was directed at generating new CPT derivatives that were water soluble. This research is discussed below.

As stated earlier, CPT and many of its derivatives (see, e.g., Wall and Wani, Camptothecin and Taxol: Discovery to Clinic-Thirteenth Bruce F. Cain Memorial Award Lecture. Cancer Res. 55:753-760 (1995)) are poorly water soluble and are also reportedly poorly soluble in a number of pharmaceutically-acceptable organic solvents as well. There are numerous reports of newly created water soluble derivatives of CPT (see, e.g., Sawada, S., Kingsbury, W. D., Luzzio, G. Synthesis and Antitumor Activity of Novel Water Soluble Derivatives of Camptothecin as Specific Inhibitors of Topoisomerase I. J. Med. Chem. 38:395-401 (1995)) which have been synthesized in an attempt to overcome some of the significant technical problems in drug administration of poorly water soluble camptothecins to patients with cancer. Several water soluble CPT derivatives have been synthesized in an attempt to address the poor water solubility and difficulties in administration to patients. Well known examples of these water-soluble CPT derivatives include: 9-dimethylaminomethyl-10-hydroxy camptothecin (Topotecan), 7-[(4-methylpiperazino)methyl]-10,11-ethylenedioxy camptothecin, 7-[(4-methylpiperazino)methyl]-10,11-methylenedioxy camptothecin, and 7-ethyl-10-[4-(1-piperidino)-1-piperidino]carbonyloxy camptothecin (Irinotecan or CPT-11).

Other substituted CPT derivatives with different solubility and pharmacologic properties have been synthesized as well; examples of these camptothecin derivatives include 9-amino camptothecin and 9-nitro camptothecin, which are poorly soluble in both aqueous and nonaqueous media and have been tested in humans. 9-nitro camptothecin is a prodrug of 9-amino camptothecin and spontaneously converts to 9-amino camptothecin in aqueous media and in vivo in mice, dogs and humans. See, e.g., Hinz, et al., Pharmacokinetics of the in vivo and in vitro conversion of 9-Nitro-20(S)-camptothecin to 9-Amino-20(S)-camptothecin in humans, dogs and mice. Cancer Res. 54:3096-3100 (1994).

The pharmacokinetic behavior of 9-nitro camptothecin and 9-amino camptothecin is similar to the water soluble camptothecin derivatives (Topotecan and Irinotecan) in that the plasma half-lives are much shorter than the more lipid soluble CPT derivatives. Another major problem with 9-amino camptothecin is that its chemical synthesis using the semi-synthetic method is carried out by nitration of CPT, followed by reduction to the amino group, which is a very low yield synthesis. In addition, 9-amino camptothecin is light-, heat-, and oxygen-sensitive; all of which render the production and stabilization of 9-amino camptothecin markedly difficult. The chemical decomposition reactions of 9-amino camptothecin can also result in the formation of compounds that exhibit a large degree of toxicity in nude mice; whereas pure 9-amino camptothecin is significantly less toxic.

Furthermore, 9-amino camptothecin is also difficult to administer to patients because it is poorly soluble in both aqueous and organic solvents. 9-nitro camptothecin is easier to produce and is more chemically stable, but with the chemical conversion to 9-amino camptothecin the drug is reportedly susceptible to MDR/MRP mediated drug resistance, which further limits its utility in the unfortunately common setting of drug resistant neoplasms. Based on pharmacokinetic behavior and chemical properties, 9-amino camptothecin is predicted to have reduced tissue penetration and retention relative to more lipid soluble camptothecin derivatives. Further, its poor solubility diminishes the amount of the drug that can cross the blood/brain barrier.

Of this diverse group of substituted CPT derivatives undergoing human clinical development, Irinotecan (CPT-11) has been one of the most extensively studied in Phase I and Phase II clinical trials in human patients with cancer. It is noteworthy that Irinotecan, which is a water soluble prodrug, is biologically inactive and requires activation by a putative carboxylesterase enzyme. The active species of Irinotecan is the depiperidenylated 10-hydroxy-7-ethyl camptothecin (claimed in Miyasaka, et al., U.S. Pat. No. 4,473,692 (1984)), which is also known as SN38. SN38 is a toxic lipophilic metabolite, which is formed by an in vivo bioactivation of Irinotecan by a putative carboxylesterase enzyme.

SN38 is very poorly soluble in water and has not been directly administered to human patients with cancer. Recently, it has been reported in human patients that SN38 undergoes further metabolism to form a glucuronide species, which is an inactive form of the drug with respect to antitumor activity, and also appears to be involved in producing human toxicity (e.g., diarrhea, nausea, leukopenia) and substantial interpatient variability in drug levels of the free metabolite and its glucuronide.

Irinotecan has been tested in human clinical trials in the United States, Europe and Japan. Nearly 100 patient deaths directly attributable to Irinotecan drug toxicity have been reported in Japan alone. The Miyasaka, et al., patents (U.S. Pat. Nos. 4,473,692 and 4,604,463) state that the object of their invention is to “provide 10-substituted camptothecins which are strong in anti-tumor activity and possess good absorbability in living bodies with very low toxicity” and “to provide new camptothecin derivatives which are strong in anti-tumor activity and possess good solubility in water and an extremely low toxicity”.

Having multiple drug-related human deaths and serious patient toxicity, is clearly a failure of the Miyasaka, et al., inventions to fulfill their stated objects. It is notable that tremendous interpatient variability with regard to drug levels of various forms, drug metabolism, certain pharmacokinetic properties and toxicity has been reported with the use of Irinotecan in human subjects with cancer. Parenteral administration of Irinotecan can achieve micromolar plasma concentrations of Irinotecan that, through metabolism to form SN38, can yield nanomolar concentrations of the active metabolite SN38. It has recently been reported in human subjects that SN38 undergoes further metabolism to form the SN38 glucuronide. See, e.g., Gupta, et al., Metabolic Fate of Irinotecan in Humans: Correlation of Glucuronidation with Diarrhea. Cancer Res. 54:3723-3725 (1994).

This further metabolic conversion of Irinotecan is important, since there is also reportedly large variability in the conversion of Irinotecan to SN38 and large interpatient variability in the metabolism of SN38 to form the inactive (and toxic) SN38 glucuronide in human subjects. See, e.g., Gupta, et al., Metabolic Fate of Irinotecan in Humans: Correlation of Glucuronidation with Diarrhea. Cancer Res. 54:3723-3725 (1994) and Ohe, Y., et al., Phase I Study and Pharmacokinetics of CPT-11 with 5-Day Continuous Infusion. NCI 84:972-974 (1992).

Since the amount of Irinotecan and SN38 metabolized is not predictable in individual patients, significant clinical limitations are posed and create the risk of life-threatening drug toxicity, and/or risk of drug inactivity due to five possible mechanisms: (i) conversion of greater amounts of Irinotecan to SN38; (ii) inactivation of SN38 by glucuronidation; (iii) conversion of SN38 glucuronide to free SN38; (iv) lack of antineoplastic activity due to the conversion of lesser amounts of Irinotecan to form SN38; and (v) lack of antineoplastic activity by more rapid and extensive conversion of SN38 to form the glucuronide species. It is important to note that even a doubling of the plasma concentration of the potent Irinotecan metabolite SN38 may result in significant toxicity, because free SN38 exhibits antineoplastic activity at nanomolar concentrations.

Another source of interpatient variability and toxicity is the in vivo de-glucuronidation of SN38 and similar CPT derivatives to produce a free and active species of the drug. Deglucuronidation of a CPT derivative that is susceptible to A-ring glucuronidation, such as SN38, results in an increase in the plasma or local tissue concentration of the free and active form of the drug, and if high enough levels were reached, patient toxicity, and even death may result.

In recent years, camptothecin development has expanded in several directions. The most interesting of these developments has occurred in the areas of silicon-containing camptothecins, also referred to as Karenitecins and silatecans, and in the development of camptothecins with a 7-membered E-ring, also referred to as homocamptothecins. The Assignee of the instant patent application has over forty three (43) United States and International Patents have issued on the Karenitecin series of HLCDs. One silicon-containing HLCD (Karenitecin®; BNP1350) has been or is currently in late-phase clinical trials in the United States, Europe, and Japan.

### SUMMARY OF THE INVENTION

The present invention comprises novel HLCDs that have the following Formula (I):

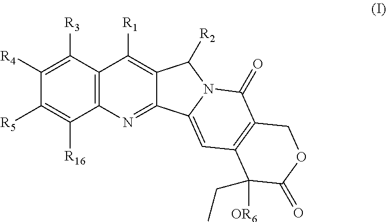

wherein R₁ is —Ge—R₇R₈R₉; lower alkylene-Ge-R₇R₈R₉; lower alkenylene-Ge—R₇R₈R₉; or lower alkynylene-Ge—R₇R₈R₉;
R₂, R₃, R₄ and R₅ are each individually hydrogen, lower alkyl, lower alkenyl, lower alkynyl, aryl, acyl, arylalkyl, arylalkenyl, arylalkynyl, amino, nitro, cyano, heterocycle, alkoxycarbonyl, amino-lower alkyl, nitro-lower alkyl, heterocycle-lower alkyl, —X-(lower alkylene, lower alkenylene, lower alkynylene, phenylene or benzylene)-SiR₁₀R₁₁R₁₂, —X-(lower alkylene, lower alkenylene, lower alkynylene, phenylene or benzylene)-NR₁₃R₁₄, or OR₁₅;
R₆ and R₁₅ are each individually hydrogen or an oxygen protecting group;
R₇, R₈, R₉, R₁₀, R₁₁, R₁₂, R₁₃, R₁₄ and R₁₆ are each individually lower alkyl, aryl or a substituted analogue thereof;
X is sulfur or a bond; and
pharmaceutically-acceptable salts and prodrugs thereof.

The present invention also provides for pharmaceutical formulations that include the Formula (I) compound as active agent, combined with one or more pharmaceutically-acceptable solvents, excipients, fillers or diluents. The invention also provides for methods of treating cancer by administering a therapeutically effective amount of the Formula I compound, or a formulation thereof.

It is a principal object of this invention to provide for novel HLCDs.

Another object is to provide for pharmaceutical formulations of the novel HLCDs, and for methods of treating susceptible cancers by administering effective amounts thereof.

### DETAILED DESCRIPTION OF THE INVENTION

The preferred embodiment herein described is not intended to be exhaustive or to limit the invention to the precise form disclosed. It is chosen and described to explain the principles of the invention, and its application and practical use to enable others skilled in the art to follow its teachings.

### Definitions

“Scaffold” means the fixed part of the molecule of the general formula given.

“Fragments” or “Moieties” are the variable parts of the molecule, designated in the formula by variable symbols, such as Rₓ, X, or other symbols. Fragments may consist of one or more of the following:
“Cₓ-C_{y} alkyl” means a straight or branched-chain aliphatic hydrocarbon containing as few as x and as many as y carbon atoms. Examples include “C₁-C₆ alkyl”, which includes a straight or branched chain hydrocarbon with no more than 6 total carbon atoms, and C₁-C₁₆ alkyl, which includes a hydrocarbon with as few as one up to as many as sixteen total carbon atoms, and others;
“Cₓ-C_{y} alkylene” means a bridging moiety formed of as few as “x” and as many as “y” —CH₂— groups;
“Cₓ-C_{y} alkenyl or alkynyl” means a straight or branched chain hydrocarbon with at least one double bond (alkenyl) or triple bond (alkynyl) between two of the carbon atoms;
“Cₓ-C_{y} alkoxy” means a straight or branched hydrocarbon chain with as few as x and as many as y carbon atoms, with the chain bonded to the scaffold through an oxygen atom;
“Lower” when used in conjunction with any hydrocarbon chain, limits the number of carbon atoms in said chain to a total of six (6). By way of non-limiting example, “lower alkyl” means C₁-C₆ alkyl.
“Alkoxycarbonyl” means an alkoxy moiety bonded to the scaffold through a carbonyl;
“Halogen” or “Halo” means chloro, fluoro, bromo or iodo;
“Acyl” means —C(O)—X, where X is hydrogen, Cₓ-C_{y} alkyl, aryl, Cₓ-C_{y} alkenyl, Cₓ-C_{y} alkynyl, aryl, etc.;
“Acyloxy” means —O—C(O)—X, where X is hydrogen, Cₓ-C_{y} alkyl, aryl, etc.;
“Cₓ-C_{y} Cycloalkyl” means a hydrocarbon ring or ring system consisting of one or more rings, fused or unfused, wherein at least one of the ring bonds is completely saturated, with the ring(s) having from x to y total carbon atoms;
“Aryl” means an aromatic ring or ring system consisting of one or more rings, preferably one to three rings, fused or unfused, with the ring atoms consisting entirely of carbon atoms;
“Arylalkyl” means an aryl moiety as defined above, bonded to the scaffold through an alkyl moiety (the attachment chain);
“Arylalkenyl” and “Arylalkynyl” mean the same as “Arylalkyl”, but including one or more double or triple bonds in the attachment chain;
“Heterocycle” means a cyclic moiety of one or more rings, preferably one to three rings, fused or unfused, wherein at least one atom of one of the rings is a non-carbon atom. Preferred heteroatoms include oxygen, nitrogen and sulfur, or any combination of two or more of those atoms; and
“Substituted” modifies the identified fragments (moieties) by replacing any, some or all of the hydrogen atoms with a moiety (moieties) as identified in the specification.

“Protecting groups” are those moieties which are attached to a particular atom, and which prevent reaction at that position of the scaffold under specified conditions. Examples of the above moieties are as follows:
C₁-C₆ alkyl (i.e., a lower alkyl) includes methyl, ethyl, propyl, isopropyl, butyl, isobutyl, sec-butyl, tert-butyl, pentyl, hexyl, amyl and the like;
C₂-C₈ alkenyl or alkynyl includes vinyl, propenyl, butenyl, acetylenyl, propynyl, and other like moieties with one or more double and/or triple bonds;
Alkoxy includes methoxy, ethoxy, propoxy, and the like;
Alkoxycarbonyl includes methoxycarbonyl, ethoxycarbonyl, and others;
Acyl includes formyl, acetyl, propionyl and others;
Acyloxy includes formoxy, acetoxy, propionoxy, and the like;
Cycloalkyl includes cyclopropyl, cyclobutyl, cyclohexyl, indanyl, dihydronaphthalenyl, cyclohexenyl, and the like;
Aryl includes phenyl, naphthyl and anthracenyl, as well as substituted variants wherein one of the hydrogen atoms bonded to the ring atom is substituted by a halogen atom, an alkyl group, or another moiety;
Arylalkyl includes benzyl, phenethyl, and the like;
Arylalkenyl and arylalkynyl includes phenyl vinyl, phenylpropenyl, phenylacetylenyl, phenylpropynyl and the like; and
Heterocycle includes furanyl, pyranyl, thionyl, pyrrolyl, pyrrolidinyl, prolinyl, pyridinyl, pyrazolyl, imidazolyl, triazolyl, tetrazolyl, oxathiazolyl, dithiolyl, oxazolyl, isoxazolyl, oxadiazolyl, pyridazinyl, pyrimidinyl, pyrazinyl, piperazinyl, oxazinyl, thiazolyl, and the like.

Substitutions for hydrogen atoms to form substituted analogues include halo, alkyl, nitro, amino (also N-substituted, and N,N di-substituted amino), sulfonyl, hydroxy, alkoxy, phenyl, phenoxy, benzyl, benzoxy, benzoyl, and trifluoromethyl.

Protecting groups include specific moieties for protecting, in particular, nitrogen terminal moieties and oxygen terminal moieties. Protecting groups are well-known in the art and are described in detail in Kocienski, P., Protecting Groups, In: Foundations of Organic Chemistry (Thieme, 1994); and Greene, W., Protective Groups in Organic Synthesis (Wiley, Second Edition, 1990).

The compounds of the present invention are highly lipophilic camptothecin derivatives (HLCDs) of the following Formula (I):

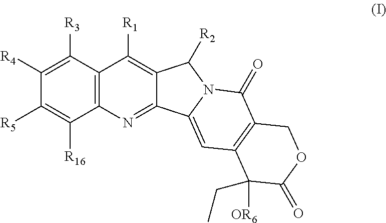

wherein R₁ is —Ge—R₇R₈R₉; lower alkylene-Ge—R₇R₈R₉; lower alkenylene-Ge—R₇R₈R₉; or lower alkynylene-Ge—R₇R₈R₉;
R₂, R₃, R₄ and R₅ are each individually hydrogen, lower alkyl, lower alkenyl, lower alkynyl, aryl, acyl, arylalkyl, arylalkenyl, arylalkynyl, amino, nitro, cyano, heterocycle, alkoxycarbonyl, amino-lower alkyl, nitro-lower alkyl, heterocycle-lower alkyl, —X-(lower alkylene, lower alkenylene, lower alkynylene, phenylene or benzylene)-SiR₁₀R₁₁R₁₂, —X-(lower alkylene, lower alkenylene, lower alkynylene, phenylene or benzylene)-NR₁₃R₁₄, or OR₁₅;
R₆ and R₁₅ are each individually hydrogen or an oxygen protecting group;
R₇, R₈, R₉, R₁₀, R₁₁, R₁₂, R₁₃, R₁₄ and R₁₆ are each individually lower alkyl, aryl or a substituted analogue thereof;
X is sulfur or a bond; and

pharmaceutically-acceptable salts and prodrugs thereof.

The present invention also includes pharmaceutical formulations suitable for administration to mammalian subjects, particularly to human patients.

The Formula I compounds of the present invention are useful cytotoxic agents that will find particular use in treating various susceptible tumors. Accordingly, the invention also provides for methods of treating mammalian subjects, in particular human patients by administering a therapeutically effective amount of a Formula I compound or a formulation containing a Formula I compound to a patient having a susceptible tumor.

The Formula I compounds may be prepared according to the following Schemes:

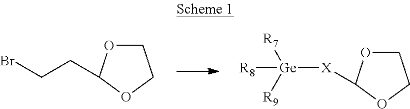

Scheme 1 illustrates the synthesis of the dioxolane germanium intermediate compound, which is used in the addition reaction to substitute the germanium-containing moiety onto the camptothecin scaffold. The synthesis is preferably accomplished through a Grignard reaction utilizing a magnesium suspension and halogenated reactants to achieve the desired substitution of the trisubstituted germanium for the corresponding halogen atom (shown in Scheme 1 as Bromine (Br)). Reaction specifics of the Grignard conversion are well-known, are set forth in the examples below and, in no manner, limit the present invention.

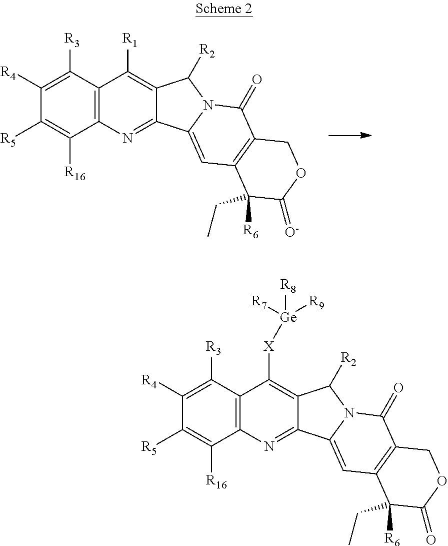

Scheme 2 illustrates the substitution of the germanium-containing moiety at C7 of the camptothecin scaffold. The synthetic process for this substitution is similar to that disclosed in U.S. Pat. No. 5,910,491 and others. The final product is formed via a modified Minisci alkylation—i.e., taking camptothecin and reacting it with the Scheme 1 intermediate in the presence of a metal sulfate, with slow addition of sulfuric acid and a strong oxidizing agent (hydrogen peroxide is most preferred) to form the germanium-substituted camptothecin as shown.

In the structures shown in Scheme 2 (above) and below, ‘X’ refers to a hydrocarbon bridge (alkylene, alkenylene, or alkynylene) of from 1 to 6 total carbon atoms, or it may be a bond if a direct bond of germanium to the scaffold is desired. By varying the hydrocarbon chain length of the intermediate used, the exact length of ‘X’ may also be varied. Substitutions at other positions along the camptothecin scaffold may be added before or after the addition of the germanium side chain.

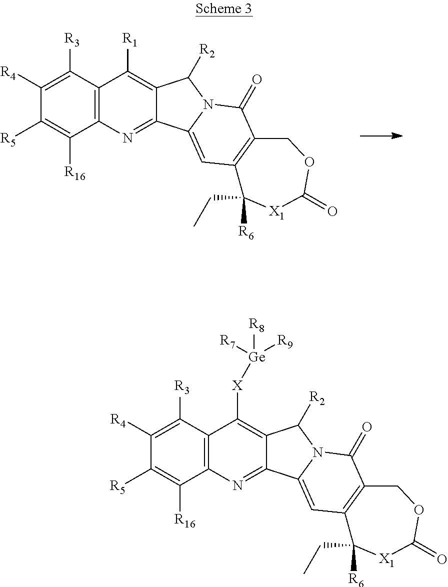

Scheme 3 illustrates the synthetic process of making a germanium-containing camptothecin where the “E′ ring” is 7- or 8-membered, as opposed to the more naturally-occurring 6-membered ring. The process is the same as that utilized in Scheme 2, with a change in the initial reactants. In this Scheme, X₁ is —CH₂— or CH₂CH₂—.

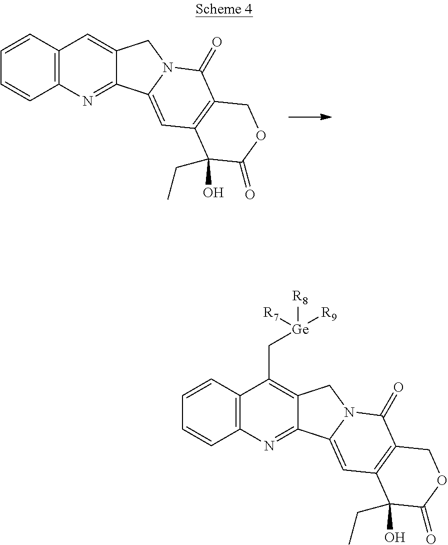

Scheme 4 illustrates the synthetic process used to make the most preferred molecule of the present invention: 7-[2′-trimethylgermanyl]ethyl-20(S) camptothecin. In this scheme, R₇, R₈, and R₉ are all methyl.

The following examples are illustrative of the synthetic process used to make the Formula (I) compounds and intermediates, and are not limitative of the present invention.

### EXAMPLE 1

### Preparation of (2-[1,3]Dioxolan-2-yl-ethyl)-trimethyl germanium

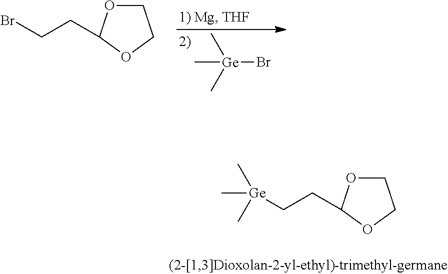

To a suspension of magnesium (0.37 g, 15.2 mmol) in tetrahydrofuran (THF) (10 mL) was added 2-(2-bromoethyl)-1,3-dioxolane (2.7 g, 13.9 mmol) at 0° C. The mixture was warmed to room temperature. After the reaction was initiated, the reaction mixture was brought back to 0-5° C. The reaction was then continued for 2 hours at 0° C. and 16 hours at room temperature. The reaction was subsequently quenched with 10 ml of ice water, extracted 3-times with 10 ml of ether and concentrated. The crude product was bulb-to-bulb distilled in a Kugelrohr apparatus to give the title product, (2-[1,3]Dioxolan-2-yl-ethyl)-trimethyl germanium, as clear oil.

¹H NMR (300 MHz, CDCl₃) [symbol] δ 4.76 (1H, t), 3.77-3.95 (4H, m), 1.57-1.65 (2H, m), 0.67-0.75 (2H, m), 0.058 (9H, s).

¹³C NMR (300 MHz, CDCl₃) δ 106.3, 65.1, 29.6, 10.4, −2.38.

### EXAMPLE 2

### Preparation of 7-[2′-trimethylgermanyl]ethyl-20(S) camptothecin (BNP1394)

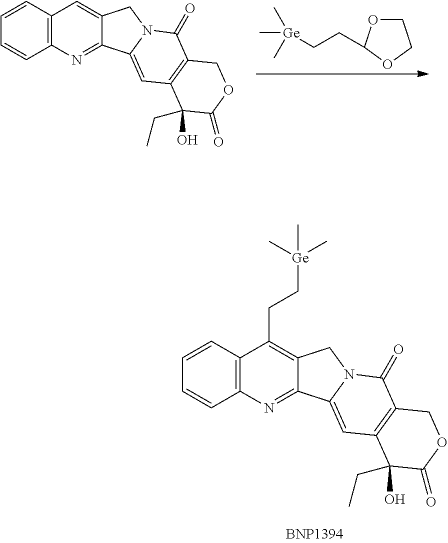

To a suspension of camptothecin (200 mg) in water (10 mL) and acetic acid (5 mL) was added FeSO₄.7H₂O (400 mg). The mixture was stirred for 10 min at room temperature. (2-[1,3]Dioxolan-2-yl-ethyl)-trimethyl-germanium (0.5 ml) was added and the resultant mixture was then cooled to 0° C. Concentrated H₂SO₄ was added dropwise followed by 30% H₂O₂ (0.3 ml). The solution was stirred at room temperature for 3 hours and the reaction was poured into ice. The aqueous phase was then extracted 3-times with 20 mL of chloroform. The combined organic extracts were washed with water, dried over anhydrous sodium sulfate, filtrated through silica gel, and concentrated by rotary evaporation. Purification by column chromatography over silica gel (50% ethyl acetate/hexanes as eluents) provided 7-[2′-trimethylgermanyl]ethyl-20(S) camptothecin (designated as BNP1394; 50 mg) as a yellow solid.

¹H NMR (300 MHz, CDCl₃) [symbol] δ 8.18 (dd, 1H, J₁=8.4 Hz, J₂=0.9 Hz), 7.99 (d, 1H, J=7.5 Hz), 7.77-7.70 (m, 1H), 7.63-7.58 (m, 2H), 5.69 (d, 1H, J=16.5 Hz), 5.25 (d, 1H, J=16.2 Hz), 5.19 (s, 2H), 3.70 (s, 1H), 3.12-3.06 (m, 2H,), 1.89-1.54 (m, 2H), 1.06-0.96 (m, 5H), 0.24 (s, 9H);

¹³C NMR (300 MHz, CDCl₃) δ 174.2, 157.9, 150.3, 149.7, 147.3, 147.0, 130.9, 130.2, 127.8, 126.8, 126.3, 123.5, 118.6, 98.2, 72.9, 66.7, 49.5, 31.8, 25.4, 17.5, 8.00, −2.26 ppm

MS (ESI) m/z 492 (M+1, 58%), 494 (M+3, 74%), 496 (M+5, 100%).

Cytotoxicity Results: Comparison of BNP1394 to BNP1350 and Other Camptothecins

Wild type human ovarian cancer cells (A2780/WT) and doxorubicin-resistant human ovarian cancer cells (A2780/DX5) were cultured in RPMI 1640 medium supplemented with 10% fetal bovine serum and 2 mM glutamine, and grown in a 37° C. incubator with 5% CO₂. BNP1350 (also designated 7-[2-trimethylsilyl)ethyl]-20(S)-camptothecin; BNP1350; and Karenitecin®); BNP1394 (also designated 7-[2′-trimethylgermanyl]ethyl-20(S) camptothecin; Topotecan; and 9-NH₂-camptothecin were synthesized and purified at BioNumerik Pharmaceuticals, Inc., and dissolved in DMSO for use in cytotoxicity experiments where inhibition of cell growth was measured using the sulforhodamine B (SRB) assay to assess cytotoxicity and absorbance at 570 nm (A₅₇₀) in order to calculate the percentage of cell control (or percent cell survival) SRB assay. See. e.g., Skehan P., Stieng R., Scudiero D., et al. New colorimetric cytotoxicity assay for anticancer-drug screen. J. Natl. Cancer Inst. 82:1107-1112 (1990)).

### Reagents

Roswell Park Memorial Institute (RPMI 1640) medium, fetal bovine serum (FBS), and L-glutamine were purchased from Gibco BRL. Drugs were dissolved in sterile dimethylsulfoxide (DMSO), from American Type Culture Collection (ATCC) for stock solutions (2.5 to 5.0 mM). Subsequent dilutions were made using cell culture medium (prior to adding the drug to cells). SRB was purchased from Sigma and dissolved in 1.0 percent acetic acid. Trichloroacetic acid was purchased from VWR International.

### Instrumentation

Cells were manipulated in a Class IIA/B3 Biological Safety Cabinet (Forma Scientific) and maintained at 37° C. in a humidified atmosphere containing 5% CO₂ in a water-jacketed cell culture incubator (Forma Scientific). Cells were counted using a Coulter-Z1 counter (Beckman-Coulter). Following drug treatment, plates were washed using a Biomek 2000 station (Beckman) and, following exposure to SRB dye, plates were washed using an automated plate washer (Model EL404, Bio-Tek Instruments). Percentage of control was correlated to A₅₇₀ values and determined using a Model EL800 plate reader (Bio-Tek Instruments).

### Cell Growth and Viability

Briefly, cells were seeded (500 cells/well in 100 μL volume) to 96-well microliter plates and allowed to attach for 24 hours prior to treatment with BNP1350, BNP1394, Topotecan, and 9-NH₂-camptothecin for 2 hours. Following this 2 hour treatment, BNP1350, BNP1394, Topotecan, and 9-NH₂-camptothecin were removed, cells were washed with drug-free media (200 μL) and then drug-free media (200 μL) was added to the cells and cells were allowed to continue growing at 37° C. with 5% CO₂ before the SRB assay was performed (total experiment time from time of seeding was 5 days, during which a total of five (5) cell-doublings occurred).

### Cell Growth and Viability

Wild-type human ovarian cancer cells (A2780/WT) and doxorubicin-resistant human ovarian cancer cells (A2780/DX5) were cultured in RPMI 1640 medium supplemented with 10% fetal bovine serum and 2 mM L-glutamine, and grown in a 37° C. incubator with 5% CO₂. Population doubling times for the two cell lines used in this study encompassed a total of five cell doublings corresponding to approximately 5 days for A2780/WT and A2780/DX5 cells. Both cell lines were maintained as monolayered cultures in T-25 or T-75 flasks and then seeded to microliter plate wells for experiments described herein.

In brief, cells were seeded (500 cells/well in 100 μL total volume) into 96-well microliter plates and allowed to attach for 24 hours prior to treatment with BNP1350, BNP1394, Topotecan, or 9-NH₂-camptothecin for 2 hours. The aforementioned compounds were dissolved in DMSO for use in cytotoxicity experiments where inhibition of cell growth was measured using the SRB assay.

Following this 2 hour drug treatment, the BNP1350, BNP1394, Topotecan, and 9-NH₂-camptothecin were removed, cells were washed with drug-free media (200 μL) and then drug-free media (200 μL) was added to the cells and cells were allowed to continue growing at 37° C. with 5% CO₂ before the SRB assay was performed (total experiment time from time of seeding was 5 days, during which time a total of 5 cell doublings had occurred).

Prior to SRB assays, cell viability was monitored by evaluation of microliter plate wells. Dead cells detach and float while living cells remain attached to the bottom of the cell well.

### Cytotoxicity Assay (SRB Assay)

The sulforhodamine B (SRB) cytotoxicity assay (see, Skehan P, et al., New colorimetric cytotoxicity assay for anticancer-drug screening. J. Natl. Cancer Inst. 82:1107-1112 (1990)) was used to determine the cytotoxic effects of BNP1350, BNP10120 or BNP10121 on cell growth in vitro. Briefly, after the medium was aspirated from individual plate wells, trichloroacetic acid (100 μL of 10.0% solution) was added to each well, and the plates were incubated at 4° C. for at least 1 hour. The plates were washed five-times with water using an automated microplate washer (Model EL 404, Bio-Tek Instruments), SRB solution (100 μL of 0.4 grams SRB dissolved in 100 mL 1.0 percent acetic acid) was added, and plates remained at room temperature for 15 minutes. The plates were then washed five-times using acetic acid (1.0%), air dried, and bound dye was solubilized in Tris base (150 μL, 10 mM). Plates were agitated (gently) for 5 minutes and the absorbance values of the SRB dye-protein adduct at a 570 nm wavelength (A₅₇₀) were determined using an automated microtiter plate reader equipped with an A₅₇₀ filter (Model EL800, BioTek Instruments).

### Experimental Results

BNP1350, BNP1394, Topotecan, and 9-NH₂-camptothecin were all inhibitors of A2780/WT and A2780/DX5 cell growth. However, BNP1350 and BNP1394 had nanomolar IC50 values and were much more potent than Topotecan or 9-NH₂-camptothecin, with nanomolar IC50 values (see, Table 1; Graph 1).

TABLE 1
Summary of IC50 Determinations in Human Ovarian Cancer Cells

| | Test | Test | Test | Test | Test | Test | Aver- | |
|---|---|---|---|---|---|---|---|---|
| | 1 | 2 | 3 | 4 | 5 | 6 | age | StDev |
| | IC50 (nM) | | | | | | | |
| | A2780/WT | | | | | | | |
| BNP1350 | 15 | 15 | 15 | 20 | 13 | 16 | 15 | 3 |
| BNP1394 | 20 | 15 | 9 | 20 | 18 | 18 | 17 | 4 |
| 9-NH₂- | 150 | 90 | 150 | 200 | 250 | 90 | 155 | 63 |
| camptothecin | | | | | | | | |
| Topotecan | 350 | 200 | 300 | 600 | 900 | 600 | 492 | 258 |
| | IC50 (nM) | | | | | | | |
| | A2780/DX5 | | | | | | | |
| BNP1350 | 15 | 15 | 15 | 24 | 10 | n/a | 16 | 5 |
| BNP1394 | 25 | 15 | 9 | 25 | 15 | 25 | 19 | 7 |
| 9-NH₂- | 600 | 250 | 250 | 550 | 600 | n/a | 450 | 184 |
| camptothecin | | | | | | | | |
| Topotecan | 550 | 800 | 2000 | 1000 | 2000 | n/a | 1270 | 685 |

### SPECIFIC EXAMPLES OF FORMULATIONS OF THE PRESENT INVENTION

In its preferred embodiments, the present invention involves the preparation and administration of germanium-containing camptothecin formulations. The following examples of the administration of these formulations illustrate selected modes for carrying out the present invention, and are not to be construed as limiting in any way.

### Example I

For injection or infusion into aqueous body fluids, a formulation comprises a total dose of from approximately 0.1 mg/m² to approximately 100 mg/m² of the germanium-containing camptothecin dissolved in 1 to 10 parts of N-methylpyrrolidinone, dimethylisosorbide and/or dimethylacetamide in an acidified vehicle comprising between approximately 10 to approximately 40 percent of an acceptable alcohol, approximately 4 to approximately 10 parts by weight of polyether glycol, and approximately 1 to approximately 10 parts of a non-ionic surfactant. Suitable alcohols include dehydrated ethyl alcohol, benzyl alcohol. Suitable polyether glycols, include polyethylene glycol 200, polyethylene glycol 300, propylene glycol. Suitable non-ionic surfactants include, but are not limited to, polysorbate-80. In a preferred embodiment, the formulation of the germanium-containing camptothecin is supplied as an intravenous injectable in a 1 mg vial comprising a sterile, nonaqueous solution of drug in a vehicle comprising dehydrated ethyl alcohol, benzyl alcohol, citric acid, polyethylene glycol 300, and polysorbate (Tween 80) in acidified medium with a pH of 3 to 4 at a final concentration of 1 mg per 1 to 2 mL

### Example II

A second formulation comprises a total dose of from approximately 0.1 mg/m² to approximately 100 mg/m² of the germanium-containing camptothecin in an acidified vehicle comprising between approximately 0.1 to 2 parts of an alcohol and approximately 1 to 10 parts of a non-ionic surfactant. Suitable alcohols include dehydrated ethyl alcohol USP, and benzyl alcohol. Suitable non-ionic surfactants include the polyoxyethylated oils, such as polyoxyethylated vegetable oils, such as castor oil, peanut oil, and olive oil. In a preferred embodiment 1 mg to 200 mg the germanium-containing camptothecin is formulated in 1 to 10 parts of N-methylpyrrolidinone, dimethylisosorbide and/or dimethylacetamide, 1 to 10 parts of Cremaphor EL™ (polyoxyethylated castor oil), 0.1 to 2 parts by weight dehydrated ethyl alcohol USP, and 0.1 to 0.9 parts citric acid to adjust the final pH between 3 to 4.

### Example III

An oral formulation of the germanium-containing camptothecin in soft gelatin capsules (e.g., comprised of gelatin/glycerin/sorbitol/purifiers) containing 1.0 part of the germanium-containing camptothecin in 1 to 10 parts of N-methylpyrrolidinone, dimethylisosorbide and/or dimethylacetamide, citric acid 0.1 to 0.5 parts by weight, glycerin 1 to 10 parts by weight, and polyethylene glycol 200 to 300 5 to 9 parts by weight, dehydrated ethyl alcohol 0.2 to 2 parts by weight of total solution weight, sodium acetate 0.05 to 0.5 parts by weight, pluronic poloxamer using 0.05 to 1.0 parts by weight, and taurocholic acid 2 to 10 parts by weight. The soft gelatin capsules may also be composed of any of a number of compounds used for this purpose including, for example, a mixture of gelatin, glycerin, sorbitol, and parabens.

It should be noted that in order to prolong the stability and solubility of the germanium-containing camptothecin for clinical infusions, the drug may diluted in 5% Dextrose in water (D5W) to a final concentration so as to provide a total dose of approximately 0.1 mg/m² to approximately 100 mg/m² of the germanium-containing camptothecin prior to injection or infusion.

Maintaining an acidic pH (i.e., pH 3 to 4) in the formulation is particularly important to reduce the slow conversion of the germanium-containing camptothecin (i.e., active form) to the E-ring-hydrolyzed carboxylate (i.e., inactive form), which occurs at physiological pH. At equilibrium under physiologic pH, the ratio of the inactive, “open-ring” form to lactone increases. Hence, hydrolysis of the lactone ring will be substantially reduced if the drug is kept in an acidic environment. The lactone form of, e.g., naturally-occurring camptothecin, as in the germanium-containing camptothecin of the present invention, is less water soluble than the carboxylate E-ring form. As previously discussed, when early clinical trials were first conducted with camptothecin using NaOH, the significance of maintaining the closed lactone ring for uniform efficacy in treating patients with cancer was poorly understood. The early reported unpredictable clinical toxicities associated with camptothecin administration may have been exacerbated by the NaOH formulation which promotes the formation of the carboxylate form, and by the relative lack of understanding of the significance of the lactone form of camptothecin as it relates to chemotherapeutic activity.

### Specific Examples of the Administration of Formulations

The foregoing description of the formulation invention has been directed to particular preferred embodiments in accordance with the requirements of the patent statutes and for purposes of explanation and illustration. Those skilled in the art will recognize that many modifications and changes may be made without departing from the scope and the spirit of the invention.

The administration of the germanium-containing camptothecin of the present invention may be carried out using various schedules and dosages. For example:
(1) For intravenous administration, a suitable dose is approximately 0.1 mg/m² to approximately 100 mg/m² in a 24 hour period which can be administered in a single or divided into multiple doses, depending upon the attending physician. This dosing regiment may be repeated for 48 hours or more. Other suitable intravenous dosing schedules range from approximately 0.1 mg/m² to approximately 100 mg/m² per day using a 3 to 5 day continuous infusion schedule every 21 to 30 days and approximately 0.1 mg/m² to approximately 100 mg/m² given as a 30 to 90 minute infusion every 21 to 30 days.
(2) A suitable oral dose of the drug is approximately 0.1 mg/m² to approximately 100 mg/m² per day using the lower dose for a period of 3 to 5 days and using divided dosages of administration of two to four times per day. Other suitable oral dosing schedules range from approximately 0.1 mg/m² to approximately 75 mg/m² per day for a period of 3 to 5 days and approximately 0.1 mg/m² to approximately 50 mg/m² per day for a period of 3 to 5 days.

It should be noted that the parenteral and oral doses can be administered under the supervision of a physician based on gradual escalation of the dosage to achieve the maximum tolerated dose in the individual patient. The oral administration schedule of the germanium-containing camptothecin may involve multiple daily doses or single daily doses for one or more consecutive days with the ability of the physician to optimize therapy by reaching the maximum effective chemotherapeutic dose that has the least toxicity in the individual patient.

In addition, patients may be given the germanium-containing camptothecin of the present invention as either an inpatient or outpatient, using the following exemplary schedules:
(1) approximately 0.1 mg/m² to approximately 100 mg/m² given over 90 minutes I.V. every 21 to 28 days;
(2) approximately 0.1 mg/m² to approximately 100 mg/m² given daily for three consecutive days over 90 minutes I.V. every 21 to 28 days;
(3) approximately 0.1 mg/m² to approximately 100 mg/m² week given once per week×3 consecutive weeks over 90 minutes I.V. with 2 weeks rest after each 3 week cycle for pretreated patients;
(4) approximately 0.1 mg/m² to approximately 100 mg/m² given once per week×3 consecutive weeks over 90 minutes I.V. for previously untreated patients with 2 weeks rest after each 3 week cycle; and
(5) approximately 0.1 mg/m²/d to approximately 100 mg/m²/d×3-5 consecutive days as a continuous i.v. infusion every 21 to 28 days.

In a preferred embodiment, the germanium-containing camptothecin is initially given at a lower dose. The dose of the germanium-containing camptothecin is then escalated at each successive cycle of treatment until the patient develops side effects which demonstrates the individual's therapeutic tolerance. The purpose of dose escalation is to safely increase the drug levels to a maximum tolerated dose and should result in increased cytotoxicity and improved chemotherapeutic activity.

Dosages can be escalated based on patient tolerance as long as unacceptable toxicity is not observed. “Unacceptable toxicity” is defined by World Health Organization (WHO) as grade 3 non-hematologic toxicity excluding nausea and vomiting and grade 4 vomiting or hematologic toxicity according to the National Cancer Institute common toxicity criteria. Since some clinical 2 5 drug toxicity is anticipated in routine clinical oncology practice, appropriate treatment will be used to prevent toxicity (e.g., nausea and vomiting) or ameliorate signs and symptoms if they are observed (e.g., diarrhea). For example, antiemetics will be administered for nausea and vomiting, antidiarrheals for diarrhea, and antipyretics for fever. Appropriate dosages of steroids/antihistamines will also be used to prevent or ameliorate any anaphylactoid toxicity if an anaphylactoid reaction is observed.

### Determination of Serum Levels

Kaneda's HPLC method and further modifications by Barilero, et al., (Simultaneous Determination of the Camptothecin Analogue CPT-11 and Its Active Metabolite HECPT by High Performance Liquid Chromatography: Application to Plasma Pharmacokinetic Studies in Cancer Patients. J. Chromat. 575:275-280 (1992)) are useful for the measuring quantities of various camptothecins (including the germanium-containing camptothecin of the present invention) in plasma and tissue.

All patents, publications, scientific articles, web sites, and other documents and materials referenced or mentioned herein are indicative of the levels of skill of those skilled in the art to which the invention pertains, and each such referenced document and material is hereby incorporated by reference to the same extent as if it had been incorporated by reference in its entirety individually or set forth herein in its entirety. Applicants reserve the right to physically incorporate into this specification any and all materials and information from any such patents, publications, scientific articles, web sites, electronically available information, and other referenced materials or documents.

The written description portion of this patent includes all claims. Furthermore, all claims, including all original claims as well as all claims from any and all priority documents, are hereby incorporated by reference in their entirety into the written description portion of the specification, and Applicants reserve the right to physically incorporate into the written description or any other portion of the application, any and all such claims. Thus, for example, under no circumstances may the patent be interpreted as allegedly not providing a written description for a claim on the assertion that the precise wording of the claim is not set forth in haec verba in written description portion of the patent.

The claims will be interpreted according to law. However, and notwithstanding the alleged or perceived ease or difficulty of interpreting any claim or portion thereof, under no circumstances may any adjustment or amendment of a claim or any portion thereof during prosecution of the application or applications leading to this patent be interpreted as having forfeited any right to any and all equivalents thereof that do not form a part of the prior art.

All of the features disclosed in this specification may be combined in any combination. Thus, unless expressly stated otherwise, each feature disclosed is only an example of a generic series of equivalent or similar features.

It is to be understood that while the invention has been described in conjunction with the detailed description thereof, the foregoing description is intended to illustrate and not limit the scope of the invention, which is defined by the scope of the appended claims. Thus, from the foregoing, it will be appreciated that, although specific embodiments of the invention have been described herein for the purpose of illustration, various modifications may be made without deviating from the spirit and scope of the invention. Other aspects, advantages, and modifications are within the scope of the following claims and the present invention is not limited except as by the appended claims.

The specific methods and compositions described herein are representative of preferred embodiments and are exemplary and not intended as limitations on the scope of the invention. Other objects, aspects, and embodiments will occur to those skilled in the art upon consideration of this specification, and are encompassed within the spirit of the invention as defined by the scope of the claims. It will be readily apparent to one skilled in the art that varying substitutions and modifications may be made to the invention disclosed herein without departing from the scope and spirit of the invention. The invention illustratively described herein suitably may be practiced in the absence of any element or elements, or limitation or limitations, which is not specifically disclosed herein as essential. Thus, for example, in each instance herein, in embodiments or examples of the present invention, the terms “comprising”, “including”, “containing”, etc. are to be read expansively and without limitation. The methods and processes illustratively described herein suitably may be practiced in differing orders of steps, and that they are not necessarily restricted to the orders of steps indicated herein or in the claims.

The terms and expressions that have been employed are used as terms of description and not of limitation, and there is no intent in the use of such terms and expressions to exclude any equivalent of the features shown and described or portions thereof, but it is recognized that various modifications are possible within the scope of the invention as claimed. Thus, it will be understood that although the present invention has been specifically disclosed by various embodiments and/or preferred embodiments and optional features, any and all modifications and variations of the concepts herein disclosed that may be resorted to by those skilled in the art are considered to be within the scope of this invention as defined by the appended claims.

The present invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein.

It is also to be understood that as used herein and in the appended claims, the singular forms “a,” “an,” and “the” include plural reference unless the context clearly dictates otherwise, the term “X and/or Y” means “X” or “Y” or both “X” and “Y”, and the letter “s” following a noun designates both the plural and singular forms of that noun. In addition, where features or aspects of the invention are described in terms of Markush groups, it is intended, and those skilled in the art will recognize, that the invention embraces and is also thereby described in terms of any individual member and any subgroup of members of the Markush group, and applicants reserve the right to revise the application or claims to refer specifically to any individual member or any subgroup of members of the Markush group.

Other embodiments are within the following claims. The patent may not be interpreted to 2 0 be limited to the specific examples or embodiments or methods specifically and/or expressly disclosed herein. Under no circumstances may the patent be interpreted to be limited by any statement made by any Examiner or any other official or employee of the Patent and Trademark Office unless such statement is specifically and without qualification or reservation expressly adopted in a responsive writing by Applicants.

What is claimed is:

1) A germanium-containing camptothecin compound, 7(2’-trimethylgermanyl]ethyl-20(S) camptothecin, having the formula: 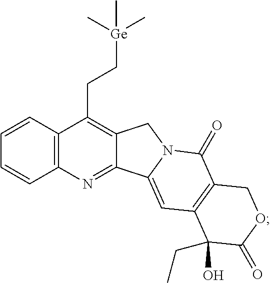
and
pharmaceutically-acceptable salts thereof.

2) A formulation containing a germanium-containing camptothecin compound of claim 1 to provide a total dose from approximately 0.1 mg/m² to approximately 100 mg/m² of said germanium-containing camptothecin compound for administration to a subject in need thereof.

3) The formulation of claim 2, wherein said formulation is administered to a subject with one or more cancers.
